(19) United States
(12) Patent Application Publication
(10) Pub. No.: US 2008/0117439 A1
(43) Pub. Date: May 22, 2008

(54) OPTICAL STRUCTURE, OPTICAL NAVIGATION SYSTEM AND METHOD OF ESTIMATING MOTION

(76) Inventors: Yat Kheng Leong, Cheras (MY); Hun Kwang Lee, Bukit Mertajam (MY); Sai Mun Lee, Sg Nibong (MY); Gladys Su Yin Fan, Penang (MY)

Correspondence Address: Kathy Manke;Avago Technologies Limited, 4380 Ziegler Road, Fort Collins, CO, 80525, US

(21) Appl. No.: 11/613,561

(22) Filed: Dec. 20, 2006

Related U.S. Application Data
(63) Continuation-in-part of application No. 11/602,876, filed on Nov. 20, 2006.

(51) Int. Cl. G01B 11/00; G01B 9/00

(52) U.S. Cl. 356/614; 359/641

(57) ABSTRACT

An optical navigation system and method of estimating motion uses an optical structure configured to collimate light propagating along a first direction and to internally reflect the light off an output reflective surface of the optical structure downward along a second direction perpendicular to the first direction toward a target surface. The optical structure is also configured to transmit the light reflected from the target surface through the output reflective surface toward an image sensor.

### REFERENCE TO RELATED APPLICATIONS

This application is a continuation-in-part of application Serial No. 11/602,876, filed Nov. 20, 2006, for which priority is claimed. The entire prior application is incorporated herein by reference.

### BACKGROUND OF THE INVENTION

Optical navigation systems operate to estimate movements between the optical navigation systems and target surfaces to perform tracking operations. An optical navigation system uses a light source, such as a light-emitting diode (LED) or a laser diode, to illuminate a region of a navigation surface and an image sensor to receive the light reflected from the target surface to successively capture frames of image data of the target surface. The optical navigation system compares the successive image frames and estimates the relative movements between the optical navigation system and the target surface based on the comparison between the current image frame and a previous image frame. The comparison is based on detecting and computing displacements of features in the captured frames of image data. For laser-based navigation systems, these features are usually interference images produced by a laser spot impinging on the target surface.

Optical navigation systems are commonly used in optical computer mice to track the movements of the mice relative to the surfaces on which the mice are manually manipulated. In order to perform the tracking operation properly, an optical mouse typically needs to be on the target surface since errors are introduced when the distance between the image sensor of the optical navigation system and the target surface is significantly increased, i.e., when the optical mouse has been lifted from the target surface. However, in certain circumstances, it is desirable that the optical navigation system can operate even when the distance between the image sensor of the optical navigation system and the target surface is increased. As an example, if the optical mouse is being used on a target surface with a sheet of glass, the optical navigation system needs to perform properly with the increased distance between the image sensor of the optical navigation system and the target surface due to the intermediate sheet of glass on the target surface.

Thus, there is a need for an optical navigation system that can perform tracking operations even when the distance between the image sensor of the optical navigation system and the target surface is increased.

### SUMMARY OF THE INVENTION

An optical navigation system and method of estimating motion uses an optical structure configured to collimate light propagating along a first direction and to internally reflect the light off an output reflective surface of the optical structure downward along a second direction perpendicular to the first direction toward a target surface. The optical structure is also configured to transmit the light reflected from the target surface through the output reflective surface toward an image sensor. Thus, the optical navigation system is able to provide collimated light that impinges the target surface at an angle normal to the target surface, which allows the optical navigation system to effectively perform tracking operations even when the distance between the image sensor of the optical navigation system and the target surface is increased due to, for example, a sheet of transparent material between the optical navigation system and the target surface.

An optical structure for use in an optical navigation system in accordance with an embodiment of the invention comprises an input portion, an intermediate portion and an output portion. The input portion includes a collimating lens positioned to receive and collimate light propagating along a first direction at an original height. The intermediate portion is attached to the input portion. The intermediate portion is configured to internally reflect the light from the collimating lens such that the light is optically manipulated to propagate along the first direction at a lower height than the original height. The output portion is attached to the intermediate portion. The output portion includes an output reflective surface orientated to internally reflect the light from the intermediate portion downward along a second direction perpendicular to the first direction toward a target surface and to transmit the light reflected from the target surface through the output reflective surface to output the light from the optical structure.

An optical navigation system in accordance with an embodiment of the invention comprises a light source, an optical structure and an image sensor. The light source is positioned to emit light along a first direction at an original height. The optical structure is optically coupled to the light source. The optical structure includes a collimating lens positioned to receive and collimate the light from the light source propagating along the first direction at the original height. The optical structure further includes an intermediate portion to internally reflect the light from the collimating lens such that the light is optically manipulated to propagate along the first direction at a lower height than the original height. The optical structure further includes an output reflective surface orientated to internally reflect the light from the intermediate portion downward along a second direction perpendicular to the first direction toward a target surface and to transmit the light reflected from the target surface through the output reflective surface to output the light from the optical structure. The image sensor is optically coupled to the optical structure to receive the light from the optical structure to capture frames of image data of the target surface.

A method of estimating motion in accordance with an embodiment of the invention comprises emitting light along a first direction at a first height, collimating the light propagating along the first direction at the original height, internally reflecting the light after the collimating such that the light is optically manipulated to propagate along the first direction at a lower height than the original height, internally reflecting the light propagating along the first direction at the lower height off an output reflective surface downward along a second direction perpendicular to the first direction toward a target surface, transmitting the light reflected from the target surface through the output reflective surface toward an image sensor, and receiving the light reflected from the target surface at the image sensor to capture frames of image data of the target surface.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows an optical navigation system included in an optical computer mouse in accordance with an embodiment of the invention.

FIG. 2 is a diagram of the optical navigation system in accordance with an embodiment of the invention.

FIG. 3 is a perspective view of an optical structure of the optical navigation system in accordance with an embodiment of the invention.

FIG. 4A is a diagram of the optical navigation system, showing optical paths of light through the optical navigation system when the optical navigation system is operating on a target surface without a sheet of transparent material between the system and the target surface.

FIG. 4B is a diagram of the optical navigation system, showing optical paths of light through the optical navigation system when the optical navigation system is operating on a target surface with a sheet of transparent material between the system and the target surface.

FIG. 5 is a process flow diagram of a method of estimating motion in accordance with an embodiment of the invention.

### DETAILED DESCRIPTION

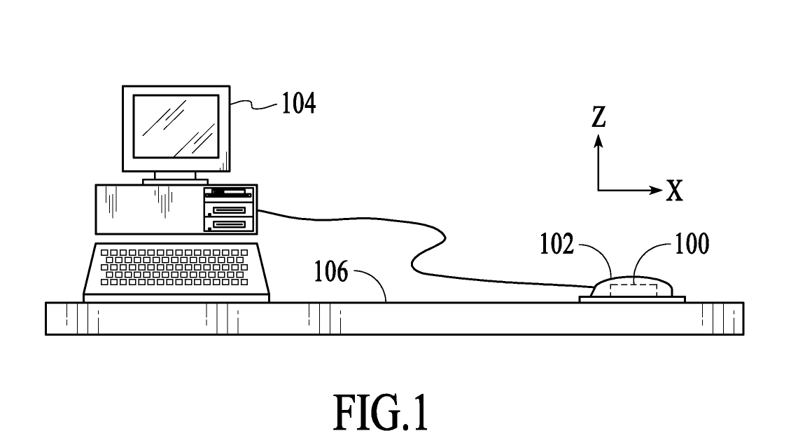

With reference to FIG. 1, an optical navigation system 100 in accordance with an embodiment of the invention is described. As shown in FIG. 1, the optical navigation system 100 is included in an optical computer mouse 102, which is connected to a computer 104. In this implementation, the optical navigation system 100 is used to track the movements of the optical mouse 102 as the optical mouse is manipulated over a target surface 106 by a user to control a cursor displayed on the computer 104. However, in other implementations, the optical navigation system 100 can be used in different products for various tracking applications. As described in detail below, the optical navigation system 100 is designed such that the optical navigation system can effectively perform a tracking operation even when the distance between the optical navigation system and the target surface 106 is increased due to, for example, a sheet of transparent material on the target surface.

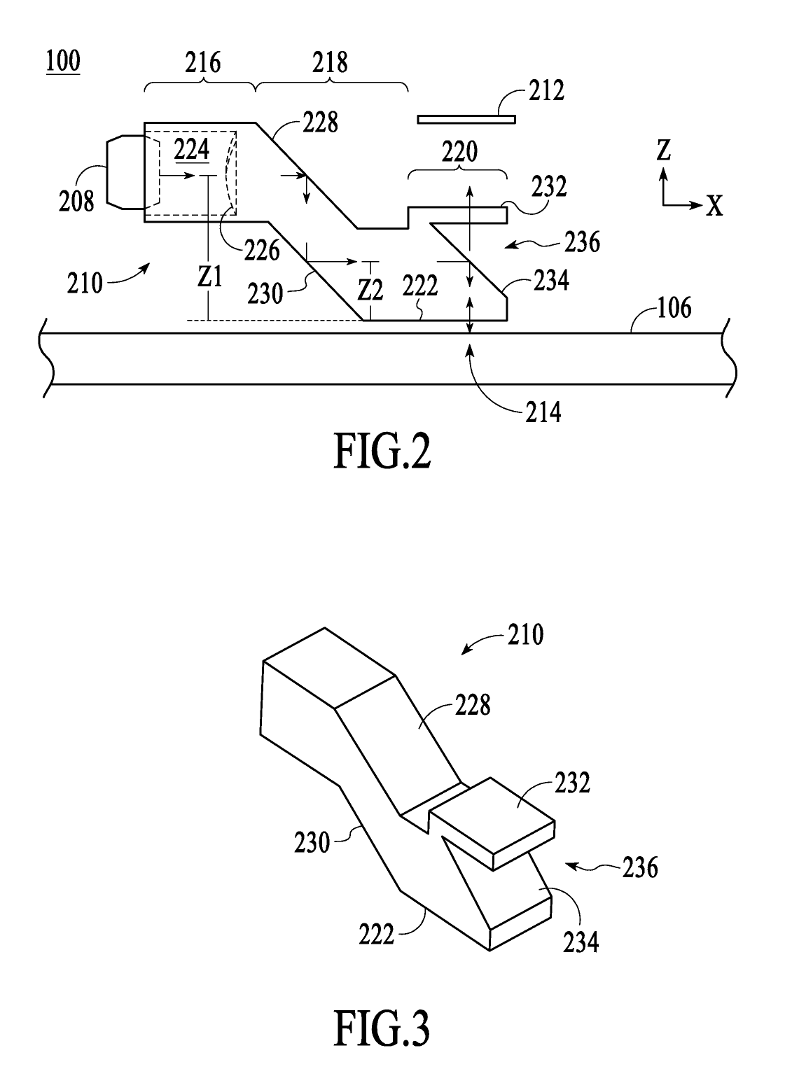

Turning now to FIG. 2, various components of the optical navigation system 100 are shown. FIG. 2 is a sectional view of the optical navigation system 100. As shown in FIG. 2, the optical navigation system 100 includes a light source 208, an optical structure 210 and an image sensor 212. The light source 208 is configured to generate light, which is used to illuminate an imaging region 214 of the target surface 106 for motion estimation. In this embodiment, the light source 208 is a laser device. Specifically, the light source 208 is a vertical-cavity surface-emitting laser (VCSEL), which generates coherent light in the form of a beam of laser light. However, in other embodiments, the light source 208 may be a light-emitting diode or any other light emitting device. The light source 208 is positioned to emit light along the positive X direction into the optical structure 210. As used herein, light propagating along a specific direction means that the central axis of the light, such as a beam of light, is along that specific direction.

The optical structure 210 is an optically transparent structure configured to collimate and optically manipulate the light received from the light source 208 toward the imaging region 214 of the target surface 106. In addition, the optical structure 210 is configured to receive the light reflected off the imaging region 214 of the target surface 106 and to transmit the reflected light to the image sensor 212. The design of the optical structure 210 allows the optical navigation system 100 to effectively operate on different surfaces, even on a surface with a sheet of transparent material, such as a sheet of clear glass or a sheet of clear plastic.

The optical structure 210 is shown in FIG. 2, as well as FIG. 3, which is a perspective view of the optical structure. As illustrated in FIG. 2, the optical structure 210 includes an input portion 216, an intermediate portion 218 and an output portion 220. The input portion 216 of the optical structure 210 is configured to receive and collimate the light from the light source 208, which is propagating along the positive X direction at a height z1 from a bottom surface 222 of the optical structure 210. The bottom surface 222 is the surface of the optical structure 210 that is closest to the target surface 106 when the optical navigation system 100 is being used on the target surface. As used herein, the height of a light propagating along a specific direction refers to the height of the central axis of that light, which may be a beam of laser light. The intermediate portion 218 of the optical structure 210 is configured to receive and optically manipulate the collimated light such that the collimated light is propagating along the positive X direction at a height z2 from the bottom surface 222, which is lower than the height z1. The output portion 220 of the optical structure 210 is configured to redirect the collimated light from the intermediate portion 218 such that the collimated light is propagating downward along the negative Z direction toward the target surface 106. The output portion 212 is also configured to receive the light reflected from the imaging region 214 of the target surface 106 and transmit the reflected light toward the image sensor 212.

The input portion 216 of the optical structure 210 includes a cavity 224 to accommodate the light source 208. In this embodiment, the light source 208 is cylindrically shaped VCSEL. Thus, the cavity 224 of the input portion 216 is a cylindrical cavity so that the light source 208 can be partially positioned in the cavity, as illustrated in FIG. 2. The cavity 224 includes a collimating lens 226 formed on a surface of the cavity. The collimating lens 226 is orientated so that the optical axis of the collimating lens is parallel with the X axis. The collimating lens 226 is configured to receive the light from light source 208, which is propagating along the positive X direction at the height z1, and to collimate the received light so that the collimated lens is propagating along the positive X direction in the optical structure 210 toward the intermediate portion 218 of the optical structure.

The intermediate portion 218 of the optical structure 210 is attached to the input portion 216 to receive the collimated light from the collimating lens 226, which is still propagating along the positive X direction at the height z1. The intermediate portion 218 includes an upper reflective surface 228 and a lower reflective surface 230, which are both sloped downward with respect to the X axis. In this embodiment, the upper and lower reflective surfaces 228 and 230 are both orientated at an angle of negative forty-five degrees (−45°) with respect to the X axis. The upper reflective surface 228 is used to internally reflect the collimated light from the collimating lens 226 downward such that the collimated light is redirected from the positive X direction to the negative Z direction. The lower reflective surface 230 is used to internally reflect the light from the upper reflective surface 228 such that the collimated light is redirected from the negative Z direction back to the positive X direction at the height z2. The overall effect of the upper and lower reflective surfaces 228 and 230 is that the collimated light is lowered from the height z1 to the height z2 but remains propagating along the positive X direction.

The output portion 220 of the optical structure 210 is attached to the intermediate portion 218 to receive the collimated light from the lower reflective surface 230, which is propagating along the positive X direction at the height z2. The output portion 220 includes the bottom surface 222 and a top surface 232. The bottom surface 220 is used to transmit the collimated light to the target surface 106 and to receive the light reflected from the target surface. The top surface 232 is used to transmit the light reflected from the target surface 106 toward the image sensor 212. In this embodiment, the top surface 232 and the bottom surface 222 are parallel to the X axis.

The output portion 220 also includes an output reflective surface 234, which is positioned between the top surface 232 and the bottom surface 222. The output reflective surface 234 is sloped downward in a manner similar to the upper and lower reflective surfaces 228 and 230 of the intermediate portion 218. In this embodiment, the output reflective surface 234 is orientated at an angle of negative forty-five degrees (−45°) with respect to the X axis. The output reflective surface 234 is a surface provided by a prism-shaped notch 236 in the optical structure 210. The output reflective surface 234 is used to internally reflect some of the collimated light from the lower reflective surface 230 of the intermediate portion 218 downward such that the collimated light is redirected from the positive X direction to the negative Z direction. The collimated light reflected from the output reflective surface 234 is then emitted from the bottom surface 222 of the optical structure 210 toward the target surface 106, which is orientated parallel to the X axis. Thus, the collimated light emitted from the optical structure 210 will impinge on the target surface 106 at an angle normal to the target surface. Consequently, the light reflected from the target surface 106 is also normal to the target surface but propagating upward along the positive Z direction. The output reflective surface 234 is also used to transmit some of the reflected light from the target surface 106 toward the image sensor 212, which is positioned above the output reflective surface. Thus, the reflected light from the target surface 106 continues to propagate along the positive Z direction through the output reflective surface 234 and the prism-shaped notch 236. The reflected light transmitted through the output reflective surface 234 and the prism-shaped notch 236 is emitted out of the top surface 232 of the output portion 220 toward the image sensor 212.

The optical structure 210 can be made of any optically transparent material, such as polycarbonate, other plastic material or any optical glasses. In this embodiment, the optical structure 210 is a monolithic structure. Thus, in this embodiment, the various components of the optical structure 210 are parts of an integral single-piece structure. However, in other embodiments, the optical structure 210 may be formed from multiple individual structures.

The image sensor 212 is positioned above the top surface 232 of the optical structure 210 to receive the light reflected off the imaging region 214 of the target surface 106 to capture frames of image data of the target surface. In particular, the image sensor 212 is positioned over the output reflective surface 234 of the optical structure 210 to receive the light reflected from the imaging region 214 of the target surface 106. The image sensor 212 includes an array of photosensitive pixel elements (not shown), which generate image signals in response to light incident on the elements. As an example, the image sensor 212 may be a charged-coupled device (CCD) image sensor or a complementary metal oxide semiconductor (CMOS) image sensor. The number of photosensitive pixel elements included in the image sensor 212 may vary depending on at least performance requirements of the optical navigation system 100 with respect to optical motion estimation. As an example, the image sensor 212 may include a 30×30 array of active photosensitive pixel elements.

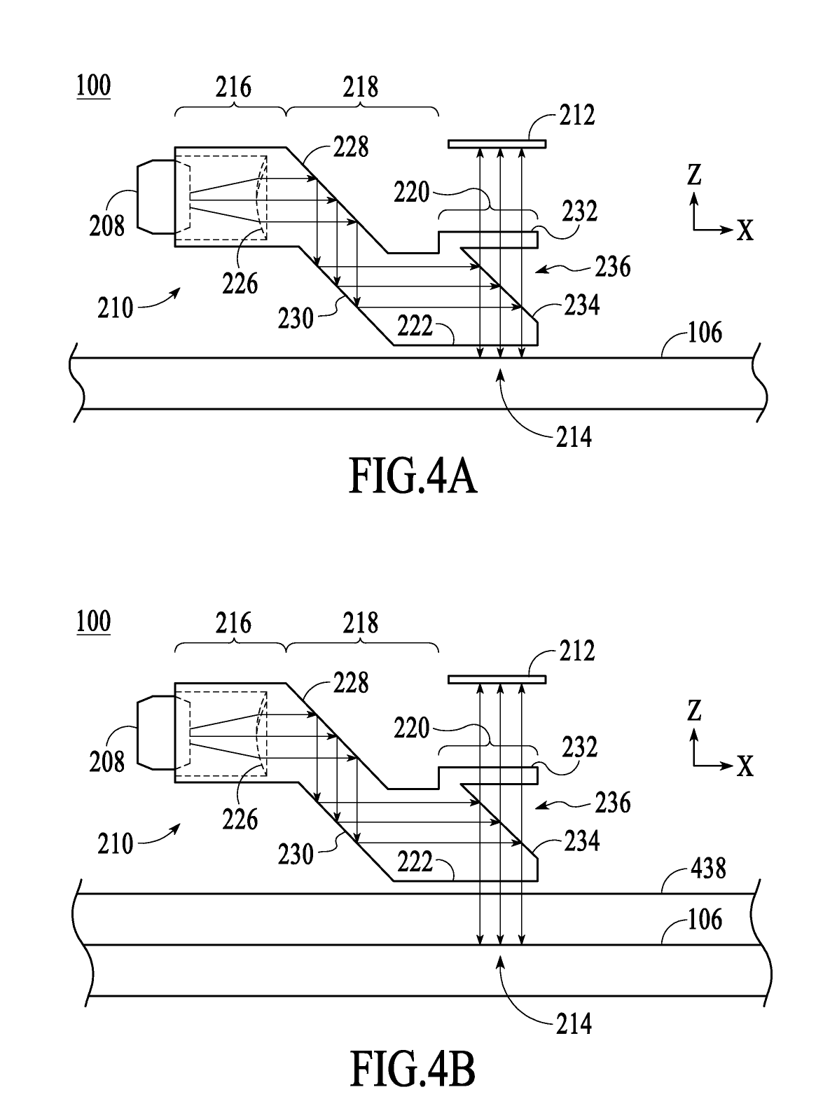

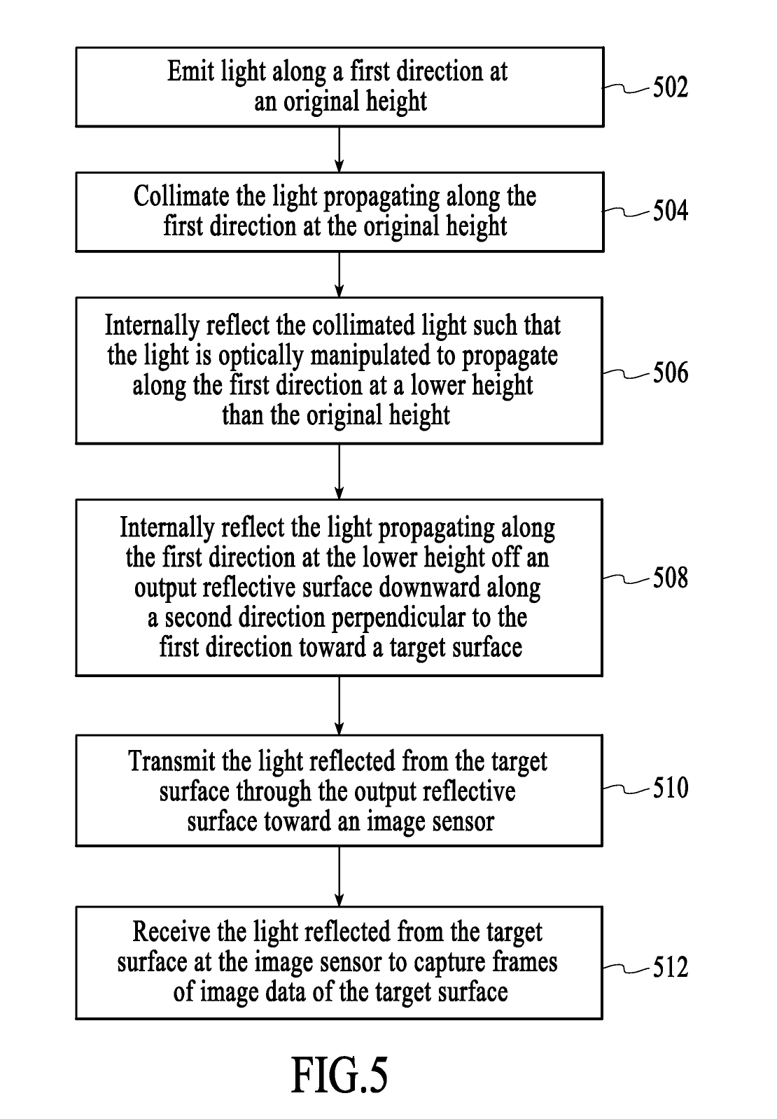

The operation of the optical navigation system 100 in accordance with an embodiment of the invention is described with reference to FIGS. 4A and 4B. FIG. 4A shows optical paths of light through the optical navigation system 100 when the optical navigation system is operating on the target surface 106 without a sheet of transparent material between the system and the target surface. As illustrated in FIG. 4A, the light emitted from the light source 208, which is propagating along the X direction at the height z1, is transmitted into the optical structure 210 at the collimating lens 226 of the input portion 216 of the optical structure. The light is then collimated by the collimating lens 228 and continues to propagate along the X direction. The collimated light is then internally reflected off the upper reflective surface 228 of the intermediate portion 218 of the optical structure 210 downward along the negative Z direction. The collimated light is then again internally reflected off the lower reflective surface 230 of the intermediate portion 218 of the optical structure 210 so that the collimated light is again propagating along the X direction but at the lower height z2.

The collimated light propagating along the X direction at the height z2 then encounters the output reflective surface 234 of the output portion 220 of the optical structure 210. Some of the collimated light is internally reflected off the output reflective surface 234 downward along the negative Z direction. The collimated light is then emitted out of the bottom surface 222 of the optical structure 210 toward the imaging region 214 of the target surface 106 at an angle normal to the target surface. The collimated light is then reflected off the target surface 106. Since the incident light on the target surface 106 is normal to the target surface, the light reflected off the target surface 106 propagates upward in a direction normal to the target surface, i.e., the positive Z direction.

The light reflected from the target surface 106, which is propagating along the positive Z direction, is transmitted into the optical structure 210 through the bottom surface 222. Some of the light is then transmitted through the output reflective surface 234 without being reflected by the output reflective surface. Thus, the light reflected from the target surface 106 continues to propagate upward along the positive Z direction through the output reflective surface 234 and the prism-shaped notch 236. The light transmitted through the output reflective surface 234 and the prism-shaped notch 236 is emitted out of the top surface 232 of the optical structure 210 toward the image sensor 212. The light is then received by the image sensor 212 to capture frames of image data of the target surface 106.

FIG. 4B shows optical paths of light through the optical navigation system 100 when the optical navigation system is operating on the target surface 106 with a sheet of transparent material 438 between the system and the target surface. As illustrated in FIGS. 4A and 4B, the optical paths of light through the optical navigation system 100 when the optical navigation system is operating on the target surface 106 with the sheet of transparent material 438 are same as the optical paths of light through the optical navigation system 100 when the optical navigation system is operating on the target surface without any sheet of transparent material. In particular, the collimated light emitted from the bottom surface 222 of the optical structure 210 propagates along the negative Z direction in both cases. Thus, the collimated light from the optical structure 210 impinges or strikes the target surface 106 at the imaging region 214 at an angle normal to the target surface 106 regardless of the vertical distance between the optical structure 210 and the target surface. Thus, the collimated light from the optical structure 210 impinges the same imaging region 214 of the target surface 106 regardless of the vertical distance between the optical structure and the target surface, which allows the optical navigation system 100 to properly track the motion between the target surface and the optical navigation system. Furthermore, computer simulation results show that there is no significant difference in beam profile and no significant offset of beam pattern whether there is or is not a sheet of transparent material between the optical navigation system 100 and a target surface. These computer simulation results also show that there is no significant difference in beam profile and no significant offset of beam pattern for changes in the thickness of the sheet of transparent material, e.g., 3 mm to 6 mm, or for changes in the refractive index of the sheet of transparent material, e.g., 1.51 to 1.71. Thus, the optical navigation system 100 can effectively perform tracking operations on transparent sheets of different thickness and different refractive index, as well as on a target surface without any transparent sheet between the target surface and the optical navigation system.

A method of estimating motion in accordance with an embodiment of the invention is described with reference to a process flow diagram of FIG. 5. At block 502, light is emitted along a first direction at an original height. Next, at block 504, the light propagating along the first direction at the original height is collimated. Next, at block 506, the collimated light is internally reflected such that the light is optically manipulated to propagate along the first direction at a lower height than the original height. Next, at block 508, the light propagating along the first direction at the lower height is internally reflected off an output reflective surface downward along a second direction perpendicular to the first direction toward a target surface. Next, at block 510, the light reflected from the target surface is transmitted through the output reflective surface toward an image sensor. Next, at block 512, the light reflected from the target surface is received at the image sensor to capture frames of image data of the target surface.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An optical structure for use in an optical navigation system, said optical structure comprising:
an input portion including a collimating lens positioned to receive and collimate light propagating along a first direction at an original height;
an intermediate portion attached to said input portion, said intermediate portion being configured to internally reflect said light from said collimating lens such that said light is optically manipulated to propagate along said first direction at a lower height than said original height; and
an output portion attached to said intermediate portion, said output portion including an output reflective surface orientated to internally reflect said light from said intermediate portion downward along a second direction perpendicular to said first direction toward a target surface and to transmit said light reflected from said target surface through said output reflective surface to output said light from said optical structure.

2. The structure of claim 1 wherein said collimating lens and said output reflective surface are parts of an integral single-piece structure.

3. The structure of claim 1 wherein said output reflective surface is sloped downward with respect to said first direction at an angle of negative forty-five degrees.

4. The structure of claim 1 wherein said intermediate portion includes an upper reflective surface and a lower reflective surface, said upper and lower reflective surfaces being sloped downward with respect to said first direction to internally reflect said light from said collimating lens such that said light is optically manipulated to propagate along said first direction at said lower height.

5. The structure of claim 4 wherein said upper and lower reflective surfaces of said intermediate portion are sloped downward with respect to said first direction at an angle of negative forty-five degrees.

6. The structure of claim 1 wherein said input portion includes a cavity, said collimating lens being a surface of said cavity.

7. The structure of claim 1 wherein said output portion includes a prism-shaped notch, said output reflective surface being a surface of said prism-shaped notch.

8. An optical navigation system comprising:
a light source positioned to emit light along a first direction at an original height;
an optical structure optically coupled to said light source, said optical structure including a collimating lens positioned to receive and collimate said light from said light source propagating along said first direction at said original height, said optical structure further including an intermediate portion configured to internally reflect said light from said collimating lens such that said light is optically manipulated to propagate along said first direction at a lower height than said original height, said optical structure further including an output reflective surface orientated to internally reflect said light from said intermediate portion downward along a second direction perpendicular to said first direction toward a target surface and to transmit said light reflected from said target surface through said output reflective surface to output said light from said optical structure; and
an image sensor optically coupled to said optical structure to receive said light from said optical structure to capture frames of image data of said target surface.

9. The system of claim 8 wherein said light source includes a vertical-cavity surface-emitting laser.

10. The system of claim 8 wherein said optical structure is an integral single-piece structure, said collimating lens and said optical reflective surface being parts of said integral single-piece structure.

11. The system of claim 8 wherein said output reflective surface of said optical structure is sloped downward with respect to said first direction at an angle of negative forty-five degrees.

12. The system of claim 8 wherein said intermediate portion of said optical structure includes an upper reflective surface and a lower reflective surface, said upper and lower reflective surfaces being sloped downward with respect to said first direction to internally reflect said light from said collimating lens such that said light is optically manipulated to propagate along said first direction at said lower height.

13. The system of claim 12 wherein said upper and lower reflective surfaces of said intermediate portion are sloped downward with respect to said first direction at an angle of negative forty-five degrees.

14. The system of claim 8 wherein said optical structure includes a cavity in which said light source is partially positioned, said collimating lens being a surface of said cavity.

15. The system of claim 8 wherein said output portion includes a prism-shaped notch, said output reflective surface being a surface of said prism-shaped notch.

16. A method of estimating motion comprising:
emitting light along a first direction at a first height;
collimating said light propagating along said first direction at said original height;
internally reflecting said light after said collimating such that said light is optically manipulated to propagate along said first direction at a lower height than said original height;
internally reflecting said light propagating along said first direction at said lower height off an output reflective surface downward along a second direction perpendicular to said first direction toward a target surface;
transmitting said light reflected from said target surface through said output reflective surface toward an image sensor; and
receiving said light reflected from said target surface at said image sensor to capture frames of image data of said target surface.

17. The method of claim 16 wherein said internally reflecting said light after said collimating includes internally reflecting said light off an upper reflective surface and a lower reflective surface, said upper and lower reflective surfaces being sloped downward with respect to said first direction.

18. The method of claim 17 wherein said upper and lower reflective surfaces are sloped downward with respect to said first direction at an angle of negative forty-five degrees.

19. The method of claim 16 wherein said output reflective surface is sloped downward with respect to said first direction at an angle negative forty-five degrees.

20. The method of claim 18 wherein said emitting said light includes emitting a beam of laser light.
